(19) United States
(12) Patent Application Publication
(10) Pub. No.: US 2011/0160111 A1
(43) Pub. Date: Jun. 30, 2011

(54) Method for Removal of Contaminants

(75) Inventor: Jens Olschimke, Hannover (DE)

(73) Assignee: SOLVAY FLUOR GMBH, Hannover (DE)

(21) Appl. No.: 13/060,427

(22) PCT Filed: Aug. 25, 2009
(86) PCT No.: PCT/EP2009/060938

§ 371 Date: Feb. 23, 2011

(30) Foreign Application Priority Data
Sep. 2, 2008 (EP) 08163490.9

(51) Int. Cl. C11D 3/20; C11D 3/60

(52) U.S. Cl. 510/109; 510/505

(57) ABSTRACT

Fluorosubstituted organic carbonates, especially monofluoroethylene, difluoroethylene, trifluoroethylene, and tetrafluorofluoroethylene carbonates can be applied as water-removing agent or to remove other liquid or solid contaminants, for example, grease and dust. Preferably, transport tanks or storage tanks are treated which are used to store the respective fluorinated carbonates for use as additive of lithium ion batteries.

The present invention concerns a method for the removal of contaminants, especially water and dust, using an acyclic or cyclic unsubstituted organic carbonate selected from the group consisting of dialkyl carbonates and 4-R-5-R′-1,3-dioxolane-2-ones wherein R is alkyl and R′ is H or a C1 to C3 alkyl group, or a fluorosubstituted organic carbonate, preferably an acyclic or cyclic unsubstituted organic carbonate or a fluorosubstituted organic carbonate selected from the group consisting of fluoroalkyl alkyl carbonates, fluoroalkyl fluoroalkyl carbonates, 4-fluoro-4-R-5-R′-1,3-dioxolane-2-ones wherein R is linear or branched alkyl and R′ is H or a C1 to C3 linear or branched alkyl group, and especially preferably an acyclic or cyclic fluorosubstituted organic carbonate selected from the group consisting of fluoroalkyl alkyl carbonates, fluoroalkyl fluoroalkyl carbonates, 4-fluoro-4-R-5-R′-1,3-dioxolane-2-ones wherein R is linear or branched alkyl and R′ is H or a C1 to C3 linear or branched alkyl group, fluoroethylene carbonate, difluoroethylene carbonate, trifluoroethylene carbonate and tetrafluoroethylene carbonate.

Fluoroethylene carbonate, the difluoroethylene carbonates (4,4-difluoro-1,3-dioxolane-2-one and especially cis- and trans-4,4-difluoro-1,3-dioxolane-2-one), trifluoroethylene carbonate, tetrafluoroethylene carbonate, fluoroalkyl alkyl carbonates, fluoroalkyl fluoroalkyl carbonates and 4-fluoro-4-R-5-R′-1,3-dioxolane-2-ones wherein R is alkyl and R′ is H or a C1 to C3 alkyl group are useful as solvents or co-solvents for use in lithium ion batteries.

It was now found that these compounds are also suitable to remove contaminants. Especially, they are suitable as water-removal agents. Likewise, other liquid or solid contaminants, for example, dust or organic liquids can be removed.

Consequently, the present invention concerns a method for the removal of water and/or other liquid or solid contaminants wherein a removal agent comprising an acyclic or cyclic unsubstituted organic carbonate, an acyclic or cyclic fluorosubstituted organic carbonate or mixtures thereof is contacted with the surface of a solid item contaminated with water and/or a solid contaminant and/or a liquid contaminant and is then separated from the contacted surface.

The term “acyclic or cyclic unsubstituted organic carbonate” denotes an organic carbonate which consists of carbon, hydrogen and oxygen. Preferred acyclic unsubstituted organic carbonates are dialkyl carbonates wherein the alkyl substitutents are the same or different and are linear or branched C1 to C5 alkyl. Most preferred compounds are dimethyl carbonate, diethyl carbonate and methyl ethyl carbonate.

Preferred cyclic unsubstituted carbonate are alkylene carbonates wherein the alkylene group has 2 to 6 carbon atoms. Preferred cyclic unsubstituted carbonates are ethylene carbonate, propylene carbonate, 1,1-dimethylethylene carbonate and 1,2-dimethylethylene carbonate.

Acyclic fluoroalkyl alkyl carbonates, acyclic fluoroalkyl fluoroalkyl carbonates with linear alkyl and fluoroalkyl groups and cyclic fluorosubstituted alkylene carbonates are especially suitable. The fluoroalkyl group and the fluoroalkylene groups are substituted by at least 1 fluorine atom; they can be substituted by 2 or more fluorine atoms and can even be perfluorinated.

Preferred acyclic fluoroalkyl (fluoro)alkyl carbonates are those which have a first C1 to C5 alkyl group, substituted by 1 or more fluorine atoms, and a second C1 to C5 alkyl group which is the same or different and is unsubstituted or substituted by 1 or more fluorine atoms; the alkyl groups can be linear or branched and preferably are linear. Most preferred compounds of this type are: Fluoromethyl methyl carbonate, bis-(fluoromethyl) carbonate, difluoromethyl methyl carbonate, difluoromethyl fluoromethyl carbonate, bis-(difluoromethyl) carbonate, trifluoromethyl methyl carbonate, trifluoromethyl difluoromethyl carbonate, bis-(trifluoromethyl) carbonate, methyl 1-fluoroethyl carbonate, methyl 2-fluoroethyl carbonate, fluoromethyl ethyl carbonate, fluoromethyl 1-fluoroethyl carbonate, fluoromethyl 2-fluoroethyl carbonate, and fluoromethyl 2,2,2-trifluoroethyl carbonate.

Preferred cyclic fluoro substituted carbonate are fluoroalkylene carbonates wherein the fluoroalkylene group has 2 to 6 carbon atoms and are substituted by at least one fluorine atom.

Cyclic fluorosubstituted alkylene carbonates are also especially suitable for performing the process of the present invention. The most preferred compounds of this type are:

Fluoroethylene carbonate, 1,1-difluoroethylene carbonate, cis and trans 1,2-difluoroethylene carbonate, trifluoroethylene carbonate, tetrafluoroethylene carbonate, propylene carbonates substituted by 1 or more fluorine atoms, especially those corresponding to the following formula:

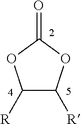

R is C1 to C3 alkyl, optionally substituted by at least 1 fluorine atom. R′ is preferably H or C1 to C3 alkyl, optionally substituted by at least 1 fluorine atom.

Suitable compounds are listed in the following table.

TABLE 1
Cyclic fluorosubstituted carbonates

| | Further substituent | | Further substituent |
|---|---|---|---|
| R | in 4-position | R′ | in 5-position |
| Methyl | F | H | H |
| Methyl | F | F | H |
| Methyl | F | F | F |
| Methyl | F | Methyl | H |
| Methyl | F | Methyl | F |
| Ethyl | F | H | H |
| Fluoromethyl | F | H | H |
| Fluoromethyl | F | F | H |
| Fluoromethyl | F | F | F |
| Difluoromethyl | F | H | H |
| Difluoromethyl | F | F | H |
| Difluoromethyl | F | F | F |
| Trifluoromethyl | F | H | H |
| Trifluoromethyl | F | H | H |
| Trifluoromethyl | F | F | H |
| Trifluoromethyl | F | F | F |
| Trifluoromethyl | H | H | H |
| Trifluoromethyl | H | H | H |
| Trifluoromethyl | F | Trifluoromethyl | F |

The carbonate compounds can be applied as single compounds or as a mixture of two or more thereof. They also can be applied together with other solvents, as will be explained later. It is preferred to apply the compounds neat, without any additive or additional solvent. It is also preferred to apply a respective compound or mixture to treat an item for removal of water and/or liquid or solid contaminants, e.g. a storage tank, a reactor, a line or a valve, which is intended to be contacted after this removal treatment with the same compound or mixture which was used for cleaning the item. For example, a storage tank intended to be used for fluoroethylene carbonate, is preferably treated with fluoroethylene carbonate as agent. For a storage tank which is intended to be used for a specific mixture of dimethyl carbonate and fluoroethylene carbonate is preferably treated with an agent composed of this specific mixture. The mixture should be essentially identical. Here the term “essentially” denotes compositions which contain the same amount of compound A and B and, if present, other compounds with a weight content of “X % by weight ±1% by weight”, preferably “X % by weight ±0.5% by weight”. For example, if a composition containing 90% by weight of ethylene carbonate and 10% by weight of fluoroethylene carbonate is to be stored in a container, the container is preferably treated with a removal agent containing 90±1% by weight of ethylene carbonate and 10±1% by weight of fluoroethylene carbonate, both components adding up to 100% by weight.

The contact can be performed by immersing the item into the liquid carbonate, or the carbonate is sprayed onto the surface or filled into the item, e.g. storage tanks. If desired, the contact between the item and the carbonate can be intensified mechanically, e.g. by rotating or shaking the item.

After the contaminant is removed from the solid item in a desired degree, the contact between the item and the carbonate is terminated. The item can for example be taken out of the carbonate, or the carbonate is let run of. If desired, the item can be dried, e.g. in a vacuum. Items which can be treated, are for example high precision components from the electronic industry, means for transport, storage or reaction, e.g. containers, for example, bottles or tanks, pipes, or reactors. Spent carbonate can be recycled, e.g. by distillation.

In a preferred embodiment, the present invention concerns a method for the removal of water and/or other liquid or solid contaminants wherein a removal agent comprising an acyclic or cyclic unsubstituted organic carbonate selected from the group of dialkyl carbonates wherein the alkyl groups are the same or different and are linear or branched C1 to C5 alkyl groups, or, in an especially preferred embodiment, wherein a fluorosubstituted organic carbonate selected from the group consisting of fluoroalkyl alkyl carbonates wherein the fluoroalkyl group is linear or branched alkyl with 1 to 5 C atoms substituted by at least one fluorine atom, and the alkyl group is linear or branched alkyl with 1 to 5 C atoms; fluoroalkyl fluoroalkyl carbonates wherein the fluoroalkyl groups are the same or different and are linear or branched alkyl with 1 to 5 C atoms, each group substituted by at least 1 fluorine atom; and 4-fluoro-4-R-5-R′-1,3-dioxolane-2-ones wherein R is C1 to C5 alkyl and R′ is H or a C1 to C3 alkyl group; mono-, di, or trifluorosubstituted propylene carbonates; mono-, di-, tri- and tetrafluoroethylene carbonates; or their mixtures of one or more of said compounds is contacted with the surface of a solid item contaminated with water and/or a solid or liquid contaminant and separated from the contacted surface.

Preferred compounds are ethylene carbonate, propylene carbonate, mono-, di-, tri- or tetrafluoroethylene carbonate, fluoromethyl methyl carbonate, 1-fluoroethyl methyl carbonate; 1-fluoroethyl ethyl carbonate, 1-fluoroethyl 2,2,2-trifluoroethyl carbonate, 4-fluoro-4-R-5-R′-1,3-dioxolane-2-ones wherein R is methyl or ethyl and R′ is H or a methyl or ethyl group, especially 4-fluoro-4-methyl-1,3-dioxolane-2-one, said fluorosubstituted compounds being especially preferred.

Mono-, di-, tri- or tetrafluoroethylene carbonate, 4-fluoro-4-R-5-R′-1,3-dioxolane-2-ones wherein R is methyl or ethyl and R′ is H or a methyl or ethyl group, especially 4-fluoro-4-methyl-1,3-dioxolane-2-one, are very preferred.

The most preferred compounds are mono-, di-, tri- or tetrafluoroethylene carbonate; the invention will now be further explained referring to these most preferred compounds.

The mono-, di-, tri- or tetrafluoroethylene carbonate or carbonates, after treatment, is or are removed from the contacted item and can be regenerated by removing water contained, e.g., by treatment with silica gel; preferably with molecular sieve, zeolites, crystallization, precipitation or by redistillation. Besides water, other possibly present impurities are removed when the process of the present invention is performed, for example, grease or adhering solids. For example dust or fine metal or polymeric particles can be removed, together with water if this is also present. The process is preferably applied to remove water from the surface of the solid. Simultaneously to the water removal, other contaminants, preferably solid contaminants, especially dust, fine metal particles, for example, due to polishing or surface-treating metallic storage tanks, and particles of polymers applied in the manufacture of the items, can be removed. For example, when neat monofluoroethylene carbonate is applied to remove water from containers intended to be filled with neat monofluoroethylene carbonate, or when neat cis-4,5-difluoroethylene carbonate is applied to remove water from containers intended to be filled with neat cis-4,5-difluoroethylene carbonate, or when neat trans-4,5-difluoroethylene carbonate is applied to remove water from containers intended to be filled with neat trans-4,5-difluoroethylene carbonate, solid contaminants, especially dust, can be removed simultaneously.

A field for the application of the fluorosubstituted organic carbonates, especially the unsubstituted dialkyl carbonates, alkylene carbonates, fluoroinated dialkyl carbonates and fluorinated alkylene carbonates, specifically the fluorinated ethylene carbonates and propylene carbonates mentioned above and their mixtures is, for example, removing water from high precision components in the electrical, electronic, optical and mechanical industry which have come into contact with water or moisture, or which might have come into contact with water (to be on the safe side). There is a risk of the water adhering to the surface of these components and then causing certain harmful effects during subsequent stages of their use or detrimentally affecting their quality. It is consequently essential, for numerous precision components, to be completely free from water adhering to the surface.

Another field which is a preferred one, where the water removal process of the present invention is to treat internal areas of three-dimensional bodies, for example, transport or storage or reaction means, e.g. containers, for example, containers, e.g. bottles or tanks, pipes, or reactors. If these internal areas have come into contact with water, it is desirable to remove this water before contacting these internal areas with chemical compounds. Also in the case where the internal areas may have come into contact with water, and one wants to be on the safe side, the process of the present invention can be performed. The process can also be applied to remove water or solid contaminants from the surface of items into which the carbonates are filled in for later use, e.g. the internal surfaces of parts intended for contact with liquids containing the fluoro carbonates, e.g. Li ion battery housings or Li ion battery cathodes and anodes.

The unsubstituted and fluorosubstituted organic carbonates, preferably the fluorosubstituted alkylene carbonate, and especially the fluorosubstituted ethylene carbonate, or a mixture of such compounds can be used in neat form as water-removing agent, and this is a preferred way of the application. If desired, the carbonate or mixture of carbonates are applied together with one or more co solvents, ideally those known to be water-removal agents. The term “co solvent” denotes an organic compound or a mixture of organic compounds which are miscible with the fluorosubstituted organic carbonate, preferably the fluorosubstituted alkylene carbonate, and especially the fluorosubstituted ethylene carbonate, in proportions by weight of 1:100 to 1:1. For example, it can be applied together with one or more co solvents selected from the group consisting of C3 to C10 hydrofluorocarbons, especially with one or more C3 to C5 hydrofluorocarbons, C5 to C10 alkanes or cycloalkanes, C1 to C10 alcohols (for example, methanol, ethanol, isopropanol, and decanol), C3 to C8 ketones (for example, acetone, methyl ethyl ketone, methyl butyl ketone, and diethyl ketone), C2 to C8 esters (for example, methyl formate, ethyl formate, methyl acetate and ethyl acetate) C2 to C8 ethers (for example, diethyl ether, methyl ethyl ether, tetrahydrofuran and 1,4-dioxan), C1 to C3 chlorinated hydrocarbons (for example, dichloromethane, trans-1,2-dichloroethylene and cis-1,2-dichloroethylene) and C2 to C4 chlorofluorinated hydrocarbons (for example 1,1-dichloro-1-fluoroethane). 1,1,1,3,3-pentafluoropropane, 1,1,1,3,3-pentafluorobutane, 1,1,1,2,2,4-hexafluorobutane, and 1,1,1,2,2,3,4,5,5,5-decafluoropentane are preferred hydrofluorocarbons. Often, compositions are applied which comprise one or more fluoroalkylene carbonates, a C3 to C10 hydrofluorocarbon and additionally one or more of the alkanes, cycloalkanes, alcohols, ketones, esters, ethers, chlorinated or chlorofluorinated hydrocarbons mentioned above.

In mixtures of the fluorosubstituted alkylene carbonate with one or more co solvents, the carbonate is present in an amount of 1 to <100% by weight.

Additionally, additives can be present, especially surface active agents. For example, salts from aliphatic fatty monocarboxylic acids or salts from aliphatic fatty monoamines. Alternatively, imidazolines can be present. Useful imidazolines are described in U.S. Pat. No. 5,948,174 the content of which is incorporated herein by reference. Preferably, the imidazoline is present in the form of a free base or in the form of a mono- or dicarboxylate salt, e.g. a laureate and oleate salt. They are commercially available under the names of Servamin®KOO 360 and Servamin®KOO 330 (sold by the firm Servo), of Imidazoline 180H, Imidazoline 12NH and Imidazoline 120H (sold by the firm Lakeland), and Miramine® (sold by the firm Rhone-Poulenc). The imidazoline content does not exceed 5% by weight of the composition. If desired, a post-treatment with a volatile solvent may subsequently be performed, e.g. with a hydrofluorocarbon.

In a preferred embodiment, the fluorosubstituted organic carbonate, preferably the fluorosubstituted alkylene carbonate, and especially the fluorosubstituted ethylene carbonate, is the only water removing agent, and is used in neat form. In a preferred embodiment, the water removal agent consists of the fluorosubstituted organic carbonate. Preferably, it consists of monofluoroethylene carbonate (sometimes denoted as fluoroethylene carbonate), or of one of said difluoroethylene carbonates, trifluoroethylene carbonate or tetrafluoroethylene carbonate. In a very preferred embodiment, the fluorosubstituted organic carbonate, especially the fluorosubstituted ethylene carbonate, is used in a neat form and in high purity. The term “high purity” denotes that the content of HF is equal to or lower than 0.01% by weight, preferably lower than 100 ppm, preferably lower than 20 ppm, especially preferably lower than 10 ppm. While the neat substance can be applied for any application intended to remove water, it is preferred that the neat water removal agent is applied to treat means which are used for transport, storage or reaction of the same respective neat and preferably pure fluorosubstituted organic carbonate. In a preferred embodiment, the neat water removal agent is applied to treat means which are used or intended to be used for transport, storage or reactions of the fluorosubstituted ethylene carbonate. For example, containers which are later to be filled with the respective neat and pure fluorosubstituted alkylenecarbonate, especially the fluorosubstituted ethylene carbonate, can be contacted with neat and pure fluorosubstituted alkylene carbonate, especially the fluorinated ethylene carbonate. The term “containers” includes, for example, bottles or tanks of any desired size, e.g. with a volume of 10 to 1000 ml or with a volume of 1 to 1000 liters and even up to 60.000 liters and more; these tanks are, for example, ISO containers. Thus, lecture bottles as well as small or large storage tanks for industrial purposes can be purified.

Another field where the process of the invention can be performed is contacting means which are used during the production of neat and pure fluorosubstituted organic carbonates. It is described in detail in view of fluorosubstituted ethylene carbonate, specifically in view of the manufacture of neat and pure fluorosubstituted ethylene carbonate, or during purification of impure fluorosubstituted ethylene carbonate to obtain neat, pure fluorosubstituted ethylene carbonate, but could as well be applied for the manufacture of fluorosubstituted acyclic carbonates. Such means include pipes, valves, reactors, distillation apparatus, stripping columns, and storage tanks. The inventive process can also be applied by contacting means which are used for handling neat, pure fluorosubstituted ethylene carbonate. For example, transport bottles or transport tanks as well as pumps, pipes or lines between storage tanks, e.g. immobile storage tanks and storage tanks on lorries or railway wagons, can be contacted with the neat, pure compound to remove any water which might be adhering to the means before these items are further contacted to start handling neat, pure compound, e.g. passing neat, pure compound from one storage tank to the other.

As mentioned above, the respective agent and the fluorosubstituted organic carbonate which later comes into contact with the treated surfaces are preferably the same. Thus, trans-4,5-difluoro-1,3-dioxolane-2-one is applied to remove water from items intended to be used for transport or storage of trans-4,5-difluoro-1,3-dioxolane-2-one. The same applies to the respective cis compound; it has a melting point around 50° C. and should be applied together with another solvent or at elevated temperature.

In a preferred embodiment, fluoroethylene carbonate is applied as water removal agent to treat storage means, handling means or transport means which are intended to be filled with fluoroethylene carbonate. The invention will now be described further in view of the use of fluoroethylene carbonate which is the preferred compound.

Fluoroethylene carbonate, as mentioned above, is used as solvent or co solvent for lithium ion batteries. This use necessitates a highly dry product. Though fluoroethylene carbonate can be dried during its production, it may happen that it takes up water during handling, for example, by contact with moist air or with moist transport or storage containers, for example, bottles or tanks. Often, fluoroethylene carbonate is stored or transported in stainless steel containers, or in polymer-coated sheet metal containers; usually, these items are polyethylene lined. While stainless steel containers can be dried by heating and blowing inert gas through them, optionally supported by applying sub-ambient pressure, this is not very well possible for PE-lined items which usually contain moisture adhering to the lining. Here, water removal by contact with dry fluoroethylene carbonate is a very simple and effective method. Among others, a great advantage is that the storage or transport items are not contacted with an additional chemical. Since filling of such storage or transport items often happens in connection with the production of fluoroethylene carbonate, the water-containing carbonate can be added to the fluoroethylene carbonate during its production and can be freed from dissolved water in the frame of that preparation process. Besides the removal of water, also other contaminations are removed, e.g. solid contaminants like dust or organic contaminations. While the advantages are especially apparent in view of items made from polymer-lined sheets, the inventive method can also be applied to remove water from steel containers. Here, energy is saved, and it is possible not only to remove water but also possible solid or organic contaminations which may be adhering to the interior of the steel items. The process can also used to clean Li ion battery parts which are in contact with fluoroethylene carbonate after assembly.

Thus, the use of the respective fluorosubstituted carbonates to remove water and, if present, grease, dust or adhering solids from items designed to come into contact with the respective neat purified fluorosubstituted carbonate, preferably the fluorosubstituted alkylene carbonate, especially the fluorosubstituted ethylene carbonate, is the preferred embodiment of the process of the present invention.

Another embodiment of the present invention is a water removal composition comprising an acyclic or cyclic fluorosubstituted organic carbonate, especially a fluorosubstituted alkylene carbonate together with at least one surfactant or an agent improving water uptake or preventing the formation of emulsions, for example, a surfactant or an imidazoline. The composition may comprise a co solvent. Preferred co solvents are selected from the group consisting of C3 to C10 hydrofluorocarbons, especially one or more C3 to C5 hydrofluorocarbons; C5 to C10 alkanes or cycloalkanes; C3 to C8 ketones (for example, acetone, methyl ethyl ketone, methyl butyl ketone, and diethyl ketone); C2 to C8 esters (for example, methyl formate, ethyl formate, methyl acetate and ethyl acetate); C2 to C8 ethers (for example, diethyl ether, methyl ethyl ether, tetrahydrofuran and 1,4-dioxan); C1 to C3 saturated chlorinated hydrocarbons or C2 and C3 unsaturated chlorinated hydrocarbons (for example, dichloromethane, trans-1,2-dichloroethylene and cis-1,2-dichloroethylene) and C2 to C4 chlorofluorinated hydrocarbons (for example 1,1-dichloro-1-fluoroethane). C1 to C10 alcohols (for example, methanol, ethanol, isopropanol, and decanol) may be used, too, but this is not preferred.

The preferred fluorosubstituted organic carbonates are those mentioned above. Most preferably, the composition comprises a fluorosubstituted organic carbonate selected from the group consisting of fluoroalkyl alkyl carbonates and fluoroalkyl fluoroalkyl carbonates wherein the fluoroalkyl groups and alkyl groups contain 1 to 5 carbon atoms and which are linear or branched, and cyclic fluoroalkylene carbonates wherein the fluoroalkylene group contains 2 to 6 carbon atoms.

It is an advantage of the process according to the present invention in its broadest form that further water removal agents are provided.

It is an advantage of the present invention in its preferred embodiment that water (and other contaminations like dust or grease) can be removed from the inner surface of items which are intended to be used for handling (e.g. for storing or transporting) of the same compound which was used as water, dust or grease removal agent.

The invention will now be described in further detail without intending to limit it.

### EXAMPLES

General remarks: The fluoroethylene carbonates applied in the examples are highly pure compounds obtainable by the direct fluorination of ethylene carbonate or fluoroethylene carbonate with elemental fluorine diluted with HF and respective purification operations. Fluoroethylene carbonate (“F1EC”), for example, can be prepared from the respective unsubstituted ethylene carbonate by the reaction of 1,3-dioxolane-2-one (ethylene carbonate; “EC”) with elemental fluorine. This is described for example in JP-A 2000-309583 where the reaction is performed with a melt of EC or its solution in anhydrous fluoride. Optionally, perfluorohexane can be present; here, a suspension of 1,3-dixolane-2-one is formed. According to US patent application 2006-0036102, ethylene carbonate is dissolved in F1EC and then contacted with fluorine. According to U.S. Pat. No. 7,268,238, the reaction is performed in a reactor with Raschig rings to provide a suitable bubble size of the fluorine gas. Di-, tri- and tetrafluoroethylene carbonate can either be prepared from ethylene carbonate wherein a respective higher proportion of fluorine is introduced into the reaction, or monofluorinated ethylene carbonate is reacted with further fluorine. The manufacture of difluoroethylene carbonate in this manner is described in JP 2000-344763. The crude reaction mixtures can be treated with water to remove HF and are then distilled. Alternatively, the aqueous workup can be omitted, and the isolation is effected by three or more distillations.

The fluoroalkyl (fluoro)alkyl carbonates can be manufactured by the stepwise reaction of COCl₂, COFCl or COCl₂ and the respective alcohols, if desired in the presence of a base, e.g. a tertiary amine, for example, triethylamine, optionally followed by a chlorine-fluorine exchange. Alkyl carbonates with an alkyl group substituted in the C-1 position can be manufactured as described in unpublished EP patent application 09165665.2.

In that process, a 1-fluoroalkyl fluoroformate of formula (II), FCHROC(O)F, or a 1-fluoroalkyl chloroformate of formula (II′), FCHROC(O)C1, is reacted with an alcohol of formula (III), R′OH, wherein R is hydrogen or a C1 to C4 alkyl group and R′ is a C1 to C5 alkyl group, optionally substituted by at least 1 fluorine atom;

or
by reacting a chloroalkyl fluoroformate of formula (IV), C1CHROC(O)F, or a chloroalkyl chloroformate of formula (IV′), C1CHROC(O)C1, wherein R has the meaning given above, with an alcohol of formula (III), R′OH wherein R′ has the meaning given above, and a subsequent chlorine-fluorine exchange.

The intermediate compounds of formula (II), FCHROC(O)F, and (IV), C1CHROC(O)F, can be produced from carbonyl fluoride or carbonyl chloride, respectively, and an aldehyde of formula RC(O)H wherein R denotes linear or branched alkyl with 1 to 5 C atoms or H. Preferably, it denotes H; here, the aldehyde is formaldehyde. The formaldehyde can be can be applied in the form of paraformaldehyde or trioxane which must be cracked, e.g. thermally, to form the monomeric formaldehyde.

The molar ratio between carbonyl fluoride or carbonyl chloride, respectively, and the aldehyde is preferably equal to or greater than 0.9:1. It is preferably equal to or lower than 5:1.

Preferably, the reaction between carbonyl fluoride or carbonyl chloride and the aldehyde is catalyzed.

The reaction can be catalyzed, for example, by F⁻. For example, the reaction can be catalyzed by HF, which may be added as such or prepared in situ by the addition of low amounts of water.

Preferred catalysts are those which contain fluoride anions, e.g. alkaline earth metal fluorides or alkali metal fluorides such as CsF, or catalysts which contain fluoride ions formed from carbonyl fluoride and a pre-catalyst. Preferred pre-catalysts are dialkyl formamides, especially dimethyl formamide. It is assumed that the formamide and carbonyl fluoride form a “naked” fluoride ion which starts a nucleophilic reaction on the aldehyde. The negatively charged oxygen of the formed adduct of the fluoride ion and the aldehyde molecule then react with a carbonyl fluoride molecule forming fluoromethyl fluoroformate or generally, the fluoroalkyl fluoroformate.

Pyridine, advantageously 4-dialkylaminopyridines, especially 4-dimethylaminopyridine, are also considered as suitable pre-catalysts.

4-fluoro-4-R-5-R′-1,3-dioxolane-2-ones can prepared, as described in unpublished EP patent application 09161429.7 by cyclization of compounds of formula (II), FC(O)OCHR′C(O)R wherein R is alkyl and R′ is H or C1 to C3 alkyl. R denotes preferably C1 to C5 alkyl, more preferably, C1 to C3 alkyl. Most preferably, R denotes methyl, ethyl, i-propyl and n-propyl. R′ preferably is H. Especially preferably, R is methyl and R′ is H.

The cyclization reaction is preferably catalyzed by a nitrogen containing heterocyclic compound or by fluoride ions. In a preferred embodiment, the heterocyclic compound is an aromatic compound. For example, pyridine or 2-methylimidazole can be used as catalyst. Especially preferred are pyridines substituted by at least one dialkylamino group. 4-Dimethylaminopyridine is very suitable. Other 4-dialkylaminopyridines, for example, those wherein alkyl denotes a C1 to C3 alkyl group, are also considered to be suitable.

The cyclization reaction is preferably performed at a temperature equal to or higher than 20° C. It is preferably performed at a temperature equal to or higher than 50° C. It is preferably performed at a temperature equal to or lower than 200° C.

The reaction is performed in the liquid phase. It can be performed batch wise or continuously.

The cyclization reaction can be performed neat or in the presence of a solvent. Suitable solvents are aprotic organic solvents. For example, ethers, esters, chlorocarbons, perfluorocarbons, chlorofluorocarbons, perfluorocarbons, hydrochlorocarbons, hydrocarbons, and aromatic hydrocarbons, for example, benzene, benzene substituted by one or more C1 to C3 alkyl groups, benzene substituted by one or more halogen atoms, are suitable. Toluene or tetrahydrofuran are very suitable. Also the respective target product, the 4-fluoro-4-alkyl-5-R′-1,3-dioxolane-2-one is a suitable solvent; workup is especially easy because no additional compound must be separated.

The produced 4-fluoro-4-R-5-R′-1,3-dioxolane-2-one can be isolated in a known manner, e.g. by distillation, crystallization or precipitation.

### Example 1

### Water Removal from a PE-Lined Transport Container Using F1EC

A PE-lined container with an inner volume of 30 liters shall be applied as transport means for highly pure fluoroethylene carbonate to be used as battery solvent. 2 liters of dry fluoroethylene carbonate (purity: >99.9% by weight) is sprayed into the container. The gaseous atmosphere in the container comprises mainly inert gas (nitrogen). The inner walls of the container comprise adherent moisture which is undesired in fluoroethylene carbonate intended as battery solvent. The container is closed, and by shaking, the inner walls are completely contacted with the fluoroethylene carbonate. Adherent moisture is removed by fluoroethylene carbonate. The container is opened, fluoroethylene carbonate is removed, and fresh highly pure fluoroethylene carbonate is filled into the container to be stored therein. Essentially no moisture can be detected in the stored fluoroethylene carbonate.

The water-containing fluoroethylene carbonate removed from the container is added to a fluoroethylene containing reaction mixture in a purification step, especially to the reaction mixture before distillation.

### Example 2

### Water Removal Using cis-4,5-difluoroethylene carbonate

Example 1 is repeated but for a container which shall be used for storage of cis-4,5-difluoro-1,3-dioxolane-2-one which is useful as a solvent for batteries. Here, the container is contacted at 60° C. with cis-4,5-difluoro-1,3-dioxolane-2-one (“cis-F2EC”). Cis-F2EC containing water can be added either to reaction mixtures from fluoroethylene carbonate production or to reaction mixtures from difluoroethylene carbonate production. The dewatered container is filled with pure cis-4,5-difluoroethylene carbonate. No moisture can be detected in the stored product.

### Example 3

### Water Removal Using trans-4,5-difluoroethylene carbonate

Example 2 is repeated but for a container which shall be used for storage of trans-4,5-difluoro-1,3-dioxolane-2-one which also is useful as a solvent for batteries. Here, the container is contacted with trans-4,5-difluoro-1,3-dioxolane-2-one (“trans-F2EC”). Cis-F2EC containing water can be added either to reaction mixtures from fluoroethylene carbonate production or to reaction mixtures from difluoroethylene carbonate production. The dewatered container is filled with pure trans-4,5-difluoroethylene carbonate. No moisture can be detected in the stored product.

### Example 4

### Water Removal with a Water-Removal Composition

A water removal composition comprises 70 parts by weight of HFC-365mfc, 30 parts by weight of trans-1,2-dichloroethylene and 15 parts by weight of fluoroethylene carbonate, obtained by mixing the constituents. A metal part comprising some moisture on its surface is immersed into the composition to remove the moisture. The treated metal part is then taken out of the composition.

### Example 5

### Water Removal with a Water-Removal Composition

A water removal composition comprises 90 parts by weight of dimethyl carbonate and 10 parts by weight of fluoroethylene carbonate, obtained by mixing the constituents. The composition is sprayed onto the inner surface of a metal storage tank comprising some moisture on its surface. The agent mixture is removed from the tank, and an identical mixture of dimethyl carbonate and fluoroethylene carbonate is filled into the tank to be stored therein.

### Example 6

### Water Removal with a Water-Removal Composition

Example 5 is repeated, with a respective mixture of propylene carbonate and fluoroethylene carbonate in said weight ratio.

### Example 7

### Water Removal with a Water-Removal Composition

Example 5 is repeated, with a respective mixture of ethylene carbonate and fluoroethylene carbonate in said weight ratio.

1- A method for the removal of water and/or other liquid or solid contaminants from a surface, said method comprising a removal treatment wherein a removal agent comprising an acyclic or cyclic unsubstituted organic carbonate, an acyclic fluorosubstituted organic carbonate or a cyclic fluorosubstituted organic carbonate or mixtures thereof is contacted with the surface of a solid item contaminated with water and/or a solid or liquid contaminant and separated from the contacted surface.

2. The method of claim 1 wherein the removal agent is applied neat.

3. The method according to claim 1 wherein the removal agent is used to treat items which are intended to be contacted, after the removal treatment, with an organic carbonate or an organic carbonate mixture essentially identical to the carbonate or carbonate mixture used for the removal treatment.

4. The method of claim 1 wherein the removal agent comprises dialkyl carbonates wherein the alkyl groups are the same or different and denote linear or branched C1 to C5 alkyl, alkylene carbonates wherein the alkylene group denotes C2 to C6 alkylene, fluoroalkyl alkyl carbonates, fluoroalkyl fluoroalkyl carbonates wherein the fluoroalkyl groups and alkyl groups are linear or branched and contain 1 to 5 carbon atoms, and cyclic fluorosubstituted fluoroalkylene carbonates wherein the fluoroalkylene group contains 2 to 6 carbon atoms.

5. The method of claim 4 wherein the removal agent is selected from the group consisting of dimethyl carbonate, methyl ethyl carbonate, ethylene carbonate, propylene carbonate, monofluoroethylene carbonate, difluoroethylene carbonate, trifluoroethylene carbonate, tetrafluoroethylene carbonate, fluoromethyl methyl carbonate, 1-fluoroethyl methyl carbonate; 1-fluoroethyl ethyl carbonate, 1-fluoroethyl 2,2,2-trifluoroethyl carbonate, and 4-fluoro-4-methyl-1,3-dioxolane-2-one.

6. The method of claim 5 wherein the removal agent is selected from the group consisting of monofluoroethylene carbonate, difluoroethylene carbonate, trifluoroethylene carbonate, tetrafluoroethylene carbonate, and their mixtures.

7. The method according to claim 6 wherein monofluoroethylene carbonate, cis-4,5-difluoroethylene carbonate or trans-4,5-difluoroethylene carbonate are applied.

8. The method according to claim 7 wherein neat monofluoroethylene carbonate, cis-4,5-difluoroethylene carbonate or trans-4,5-difluoroethylene carbonate are applied.

9. The method according to claim 8 wherein neat monofluoroethylene carbonate is applied to remove water from containers intended to be filled with neat monofluoroethylene carbonate, or wherein neat cis-4,5-difluoroethylene carbonate is applied to remove water from containers intended to be filled with neat cis-4,5-difluoroethylene carbonate, or wherein neat trans-4,5-difluoroethylene carbonate is applied to remove water from containers intended to be filled with neat trans-4,5-difluoroethylene carbonate.

10. The method according to claim 9 wherein other contaminants are removed simultaneously.

11. The method according to claim 9 wherein monofluoroethylene carbonate, cis-4,5-difluoroethylene carbonate or trans-4,5-difluoroethylene carbonate are used to clean containers which are intended to store the respective fluorinated carbonate for use as additive for Li ion battery electrolyte solvents, or to clean Li ion battery parts.

12. A composition suitable for water removal, comprising an acyclic or cyclic unsubstituted organic carbonate or an acyclic or cyclic fluorinated organic carbonate and at least one surfactant.

13. The composition of claim 12 wherein the composition comprises an acyclic or a cyclic fluorinated organic carbonate.

14. The composition of claim 13 wherein the fluorinated organic carbonate is selected from the group consisting of fluoroalkyl alkyl carbonates and fluoroalkyl fluoroalkyl carbonates wherein the fluoroalkyl groups and alkyl groups are linear or branched, and contain 1 to 5 carbon atoms, and cyclic fluoroalkylene carbonates wherein the fluoroalkylene group contain 2 to 6 carbon atoms.

15. The composition of claim 14 wherein the fluorinated organic carbonate is selected from the group consisting of monofluoroethylene carbonate, difluoroethylene carbonate, trifluoroethylene carbonate, tetrafluoroethylene carbonate, and their mixtures.

16. The method according to claim 10 wherein the other contaminant is dust.
